(19) United States
(12) Patent Application Publication
(10) Pub. No.: US 2009/0325446 A1
(43) Pub. Date: Dec. 31, 2009

(54) ORGANIC DAMPING MATERIAL

(75) Inventors: Mitsuo Hori, Gifu-Shi (JP); Akira Saitou, Nagoya-shi (JP); Takashi Hori, Kasugai-shi (JP)

Correspondence Address: WILSON, SONSINI, GOODRICH & ROSATI, 650 PAGE MILL ROAD, PALO ALTO, CA, 94304-1050, US

(73) Assignee: As R&D LLC, Gifu-shi (JP)

(21) Appl. No.: 12/488,467

(22) Filed: Jun. 19, 2009

Related U.S. Application Data
(63) Continuation of application No. PCT/JP2007/073990, filed on Dec. 13, 2007.

(30) Foreign Application Priority Data
Dec. 20, 2006 (JP) 2006-342357
Mar. 26, 2007 (JP) 2007-080333

(51) Int. Cl. B32B 27/00; G10K 11/162; B32B 27/40; B32B 27/34; B32B 27/32; C08K 5/435; C08K 5/18

(52) U.S. Cl. 442/327; 252/62; 428/412; 428/423.1; 428/430; 428/435; 428/441; 428/458; 428/461; 428/462; 428/463; 428/473.5; 428/474.4; 428/500; 521/143; 521/146; 521/149; 521/155; 524/168; 524/186; 524/323

(57) ABSTRACT

An organic damping material which by itself has excellent damping properties without being combined with other material(s), need not have a certain thickness or volume for ensuring sufficient damping performance, and is easy to process. It is characterized by comprising a polymer matrix phase and a phase dispersed therein comprising one or two or more compounds selected among-(p-toluenesulfonylamido)diphenylamine, 4,4′-bis(α,α-dimethylbenzyl)diphenylamine, octylated diphenylamine, 2,2′-methylenebis(4-ethyl-6-tert-butylphenol, 4,4′-thiobis(3-methyl-6-tert-butylphenol.

### CROSS-REFERENCE

This application is a continuation of PCT/JP2007/073990 filed on Dec. 13, 2007 and claims the benefit of this application under 35 USC §365, which claims the benefit of Japanese Patent Application No. 2007-080333, filed Mar. 26, 2007, and Japanese Patent Application No. 2006-342357, filed Dec. 20, 2006, each of which are incorporated herein by reference in their entirety.

### BACKGROUND OF THE INVENTION

As a vibration inhibiting material, for example, a vibration inhibiting sheet made of a composition comprising an inorganic filler blended in a base polymer, has been conventionally known (for example, see Japanese Patent Application Laid-Open (JP-A) No. 5-25359).

However, with this vibration inhibiting material, an excellent vibration inhibiting performance, i.e., tan δ of more than 2.0, cannot be obtained just by adding a filler.

Further, a porous molded article made of a fibrous material is known as a sound absorbing material (for example, see JP-A-2-57333).

However, this sound absorbing material has a mechanism that sound energy is absorbed as frictional heat as the sound passes through the molded article while being repeatedly hit with it. Accordingly, a certain thickness or volume is required in order to obtain a sufficient level of sound absorbing property, and therefore it is disadvantageous in that the material cannot be applied for a specific use which does not provide space required therefor.

In addition, known as an impact absorbing material is a foamed molded article made of a foamed polymer component (for example, see Japanese Patent Application Publication (JP-B) No. 8-5983) or a foam containing fibers dispersed therein (for example, see JP-A-6-300071).

However, these impact absorbing materials have a structure that, whenever impact is applied to the material, the foam structure is broken to absorb impact energy.

Accordingly, the impact absorbing material has a disadvantage that, in order to ensure a sufficient sound absorbing property, a certain thickness or volume is required, and thus the material cannot be applied for a specific use which does not provide space required therefor.

In addition, a transparent conductive paint, etc., comprising at least metal colloids with average particle diameter of 0.05 micron or less, is known as an electromagnetic wave absorbing material (for example, see JP-A-9-53030).

However, such an electromagnetic wave absorbing material has the following problem. If a film thickness or fine-line pattern is adjusted to the level of achieving transparency, surface resistance of a conductive layer becomes too high, and therefore a shielding effect (i.e., an electromagnetic wave absorbing property) is lowered. As a consequence, a shielding effect of 30 dB or more cannot be obtained for a high frequency range such as 300 MHz or more, for example.

Moreover, as a vibration proofing material, a rubber mainly made of a natural rubber (NR) is the best in terms of vibration proofing performance. Therefore, it has been conventionally used as a vibration proofing rubber.

However, such a vibration proofing material consisting only of a rubber material fails to provide a sufficient level of vibration proofing effect. Further, it is usually used as a composite obtained by laminating the rubber material to a steel plate, etc. to form a single body. For this reason, there is a demand for a simple structure consisting only of a vibration proofing material without being combined with other materials.

### SUMMARY OF THE INVENTION

The present invention relates to an organic damping material which can be used for a variety of applications including a vibration inhibiting material, a sound absorbing material, a vibration proofing material, an impact absorbing material, or an electromagnetic wave absorbing material, etc., and is particularly preferable for a constrained vibration inhibiting member, a laminated glass, or a sound proof panel, etc.

As explained above, conventionally known energy damping materials are limited in that, for example, performances are not satisfactory or a certain thickness or volume is required to obtain sufficient performance.

The present invention has been devised in view of the technical problems to be solved, and an object of the invention is to provide an organic damping material which by itself has excellent damping properties without being combined with other material(s), need not have a certain thickness or volume for ensuring sufficient damping performance, and is easy to process.

Another object of the present invention is to provide an organic damping material which by itself has properties including an excellent vibration inhibiting property, sound absorbing property, vibration proofing property, impact absorbing property or electromagnetic wave absorbing property without being combined with other material(s).

To achieve the above objects, the present invention is mainly related to an organic damping material comprising a polymer matrix phase and a phase dispersed therein comprising one or two or more compounds selected among p-(p-toluenesulfonylamido)diphenylamine, 4,4′-bis(α,α-dimethylbenzyl)diphenylamine, octylated diphenylamine, 2,2′-methylenebis(4-ethyl-6-tert-butylphenol),and 4,4′-thiobis(3-methyl-6-tert-butylphenol).

As having the constitution described above, the organic damping material of the invention by itself has an excellent damping property without being combined with other material(s) In addition, the organic damping material of the invention is advantageous in that it is not required to have a certain thickness or volume for ensuring sufficient damping performance, and is easy to process.

Furthermore, the organic damping material of the invention by itself has properties including an excellent vibration inhibiting property, sound absorbing property, vibration proofing property, impact absorbing property or electromagnetic wave absorbing property without being combined with other material(s). Therefore, the material can be used for an application in which multiple functions are simultaneously required.

### BRIEF DESCRIPTION OF THE DRAWINGS

FIG. 1 is a graph showing measurement results of loss tangent (tan δ) for a vibration inhibiting varnish of Example 1 and Comparative example 1 in the temperature range of −20° C. to 120° C.

FIG. 2 is a graph showing measurement results of resilience elasticity for Example 2 and Comparative examples 2 and 3.

FIG. 3 is a graph showing evaluation results of vibration inhibiting performance (tan δ) for each of the vibration inhibiting sheets of Examples 3 and 4 and Comparative example 4.

FIG. 4 is a graph showing evaluation results of vibration inhibiting performance (tan δ) for each of the vibration inhibiting sheets of Examples 5 to 10 and Comparative example 5.

FIG. 5 is a graph showing evaluation results of vibration inhibiting performance (tan δ) for each of the vibration inhibiting sheets of Examples 11 to 15 and Comparative example 6.

FIG. 6 is a graph showing evaluation results of vibration inhibiting performance (tan δ) for each of the vibration inhibiting sheets of Example 16 and Comparative example 7.

FIG. 7 is a graph showing evaluation results of vibration inhibiting performance (tan δ) for each of the vibration inhibiting sheets of Examples 17 to 22 and Comparative example 8.

FIG. 8 is a graph showing evaluation results of vibration inhibiting performance (tan δ) for each of the vibration inhibiting sheets of Example 23 and Comparative example 9.

### DETAILED DESCRIPTION

Hereinbelow, an organic damping material of the present invention will be described in more detail. The organic damping material of the invention is characterized by comprising a polymer matrix phase and a phase dispersed therein comprising one or two or more compounds selected from p-(p-toluenesulfonylamido)diphenylamine, 4,4′-bis(α,α-dimethylbenzyl)diphenylamine, octylated diphenylamine, 2,2′-methylenebis(4-ethyl-6-tert-butylphenol), and 4,4′-thiobis(3-methyl-6-tert-butylphenol).

As a polymer constituting the matrix phase of the organic damping material of the invention, a thermoplastic resin, a thermoplastic elastomer, a thermosetting resin, a rubber, a gel or a water-based emulsion, etc. can be used, depending on specific use or condition for use.

Examples of thermoplastic resin include one or two or more selected from general-purpose plastics and engineering plastics. Examples of the general-purpose plastics include one or two or more selected from polyolefins such as polyethylene (PE), polypropylene (PP), and copolymer thereof, preferably polyolefin which is grafted or copolymerized with a polar group like carboxylic acid and epoxy, polyvinyl chloride (PVC), polystyrene (PS), an acrylonitrile butadiene styrene copolymer (ABS), an acrylonitrile styrene copolymer (AS), polymethyl methacrylate (PMMA), chlorinated polyethylene (CPE) and an ethylene vinyl acetate copolymer (EVA).

Examples of the engineering plastics include one or two or more selected from the group consisting of polyamide (PA), polyacetal (POM), polycarbonate (PC), polyphenylene ether (PPE), polybutylene terephthalate (PBT), polymethyl pentene (TPX), syndiotactic polystyrene (SPS), polysulfone (SPF), polyether sulfone (PES), polyphthalamide (PPA), polyphenylene sulfide (PPS), polycyclohexylenedimethylene terephthalate (PCT), polyarylate (PAR), polyether imide (PEI), polyetherether ketone (PEEK), thermoplastic polyimide (PI), liquid crystalline polymer (LCP), a fluorocarbon resin, polyether nitrile (PEN), polyethylene terephthalate (PET), modified polyphenylene ether (mPPE), polylsulfone (PSF) and polyamide imide (PAI), and copolymers thereof. In addition, the polymer employed as engineering plastics includes no polyacetal (POM).

Examples of the thermoplastic elastomer include one or two or more selected from thermoplastic styrene (TPS), thermoplastic polyolefin (TPO), thermoplastic polyurethane (TPU), a thermoplastic polyester elastomer (TPEE), a thermoplastic vulcanized elastomer (TPV), a thermoplastic vinylchloride elastomer (TPVC), a thermoplastic polyamide elastomer (PEBAX), and a thermoplastic butyl rubber elastomer which is partially cross-linked with organic peroxide, or copolymers thereof, or a thermoplastic elastomer consisting of a styrene-vinyl isoprene block copolymer, and a mixture or copolymer of polypropylene and a styrene elastomer.

Examples of the thermosetting resin include one or two or more selected from a phenol resin, a urea resin, a melamine resin, an unsaturated polyester resin, a diallylphthalate resin, an epoxy resin, a urethane resin and a silicone resin, and copolymers thereof.

Example of the rubber include one or two or more selected from polybutadiene (PB), a nitrile rubber (NBR), a natural rubber (NR), a butyl rubber (IIR), a styrenebutadiene rubber (SBR), a chloroprene rubber (CR), a fluoro rubber and a silicone rubber, and copolymers thereof.

Examples of the gel include one or two or more selected from a urethane gel and a silicone gel.

Examples of the water-based emulsion resin include one or two or more selected from polymethyl methacrylate (PMMA), polystyrene (PS), ethylene vinyl acetate copolymer (EVA) and polyurethane.

Further, for selecting a polymer component constituting the above-described matrix phase, it is preferable to consider, not only to compatibility with p-(p-toluenesulfonylamido)diphenylamine described below, but also a handling property, a molding property, availability, performance under various temperatures (i.e., heat resistance or cold resistance), weatherability, cost and the like depending on a material to which the organic damping material is applied (i.e., use) or on a condition of use.

The organic damping material of the invention has a structure including the polymer matrix phase and a phase dispersed therein comprising one or two or more compounds selected from p-(p-toluenesulfonylamido)diphenylamine, 4,4′-bis(α,α-dimethylbenzyl)diphenylamine, octylated diphenylamine, 2,2′-methylenebis(4-ethyl-6-tert-butylphenol), and 4,4′-thiobis(3-methyl-6-tert-butylphenol) (herein below, simply referred to as the “present compound”).

The present compound is mixed in a polymer which constitutes the matrix phase described above to form a dispersion phase in the matrix phase and has a function of damping energy such as vibration, sound, impact or an electromagnetic wave, that is applied to the organic damping material.

The dispersion phase is a phase wherein the present compound is present in a matrix as a dispersion phase having a microphase separation structure or as a completely solubilized dispersion phase. In addition, this dispersion phase is preferably present in the matrix phase in an average size of 1 micron or less, more preferably 0.1 micron or less, for achieving more efficient exhibition of the energy damping property described above.

The present compound constituting the dispersion phase is preferably contained in a ratio of 1 to 200 parts by weight compared to 100 parts by weight of the polymer constituting the matrix phase. If the content of the present compound is less than 1 part by weight, a sufficient level of energy damping property cannot be obtained. If it is more than 200 parts by weight, on the other hand, damping effect is not obtained for the extra amount, and therefore economically unfavorable.

Furthermore, in addition to the components described above, other materials such as mica scale, glass chips, glass fiber, carbon fiber, calcium carbonate, barite, and precipitated barium sulfate, or an anti-corrosive agent, a pigment, an anti-oxidant, an anti-static agent, a stabilizing agent, and a wetting agent can be suitably added, if desired, to the organic damping material of the present invention.

When the organic damping material of the invention is prepared as a solid form such as a sheet or a film, the present compound is blended in a certain ratio to the polymer component constituting the matrix phase, kneaded by using a Banbury mixer or a roller, etc., and further molded by a calendaring method or an extrusion method thereby in a desired shape.

When the organic damping material is prepared as gel or an emulsion, the present compound is added in a certain ratio to the gel or the water-based emulsion to be mixed until a homogeneous dispersion state is obtained.

When the organic damping material is prepared as a solid form such as a sheet or a film, the organic damping material may have a foam structure. Foam level is not specifically limited. However, an open cell structure is preferred for use requiring a sound absorbing property or a vibration inhibiting property, and a closed cell structure is preferred for use requiring a vibration proofing property or an impact absorbing property.

Further, when the organic damping material of the invention is prepared as a solid form such as a sheet or a film, a constraining layer can be formed on one or two sides thereof. By forming a constraining layer, there arises a difference between the organic damping material and the constraining layer when vibration or sound is applied to the damping material. Based on such difference, vibration or sound energy can be lost, and therefore can be dampened. For such reasons, it is preferable that a constraining layer is made of a material with higher hardness than the organic damping material, and the organic damping material is constrained by the constraining layer. Specific examples of the constraining layer include a sheet, a film, a net, a plate or a composite thereof which is made of one or more materials selected from a metal, a polymer, a rubber, a glass and non-woven fabrics.

The organic damping material of the invention can efficiently dampen energy such as vibration, sound, impact or electromagnetic wave that is applied to the damping material. However, there are various types of vibration, sound, impact or electromagnetic wave applied to the material. In this regard, according to the organic damping material of the invention, it is possible to deal with various types of vibration, sound, impact or electromagnetic wave by adjusting thickness of the organic damping material. For example, when damping of high frequency sound is required, the thickness of the organic damping material is reduced. On the contrary, when damping of low frequency sound is required, the thickness of the organic damping material is increased. Vibration, impact and electromagnetic wave can also be dealt with similarly.

The organic damping material of the invention can be applied for a wide range of use. Examples of specific use thereof include a vibration inhibiting material such as a vibration inhibiting sheet, a vibration inhibiting film, a vibration inhibiting paper, vibration inhibiting paint, vibration inhibiting powder paint, vibration inhibiting varnish, vibration inhibiting adhesives, a constrained vibration inhibiting member, and a vibration inhibiting steel plate; a sound absorbing material such as a sound absorbing sheet, a sound absorbing film, a sound absorbing foam, a sound absorbing fiber, and sound absorbing non-woven fabrics; an impact absorbing material used for a grip end for a tennis or badminton racket etc., a shoe sole, a grip for a bicycle or a motorcycle etc, an impact absorbing tape, or an impact absorbing gel or rubber; an electromagnetic wave absorbing material used for a shield for absorbing an electromagnetic wave; a vibration proofing material used for a vibration proofing rubber or a vibration proofing gel etc.; and a heat storing paint material.

Further, since the organic damping material of the invention by itself has properties including an excellent vibration inhibiting property, sound absorbing property, vibration proofing property, impact absorbing property or electromagnetic wave absorbing property, etc. without being combined with other material(s), it can be used for an application in which multiple functions are simultaneously required. For example, in the case of a laminated glass which is typically used for a vehicle or a house window etc., multiple functions including a vibration inhibiting property, a sound absorbing property or an electromagnetic wave absorbing property are required simultaneously. In this regard, since the organic damping material of the invention by itself has an excellent vibration inhibiting property, sound absorbing property, or electromagnetic wave absorbing property, while still maintaining transparency, it is the most appropriate for an intermediate layer of the laminated glass.

Still further, examples of other use of the organic damping material of the invention include a sound-proof panel that is installed along the sides of a road such as freeway. The sound-proof panel which is installed along the sides of a road such as freeway is provided mainly for blocking noises from the road. Recently, an ETC system is adopted in freeways by which toll fees are paid automatically based on wireless communication between an antenna installed at a toll gate and a device installed in vehicle so that the vehicle can freely pass the toll gate without making a stop. However, the electric wave transmitted from the antenna of the ETC system spreads around the road and neighborhood. As a result, complaints are reported that the electric wave causes a malfunction of a neighboring household electric equipment or incorrect toll fees are applied to a vehicle because an electric wave from the ETC system is transmitted to the device of the vehicles that are driving on the road led to the freeway, etc., for example. In this regard, if a sound-proof panel made of the organic damping material of the invention is installed along the sides of a road, the above inconvenience can be avoided with absorption of an electromagnetic wave, in addition to the intrinsic effect of a sound-proof panel such as sound absorption, vibration inhibition, and sound blocking.

### Examples

Hereinbelow, evaluation of a damping property of a vibration inhibiting material (i.e., vibration inhibiting varnish) and a vibration proofing material is described.

### Example 1

90 parts by weight of 2-hydroxyethyl methacrylate and 10 parts by weight of p-(p-toluenesulfonylamido) diphenylamine as a diluent were added to 100 parts by weight of a main component comprising an epoxy-modified unsaturated polyether resin (50% by weight) and 2-hydroxyethyl methacrylate (50% by weight). 100 parts by weight of the mixture was blended with 2 parts by weight of a hardening agent comprising 1,1-di(t-butylperoxy)cyclohexane (70% by weight), ethylbenzene (28% by weight) and cyclohexanone (2% by weight), followed by heating at 130° C. for three hours under stirring to obtain a vibration inhibiting varnish.

### Comparative Example 1

A vibration inhibiting varnish was obtained in the same manner as Example 1, except that p-(p-toluenesulfonylamido)diphenylamine as a diluent was not added.

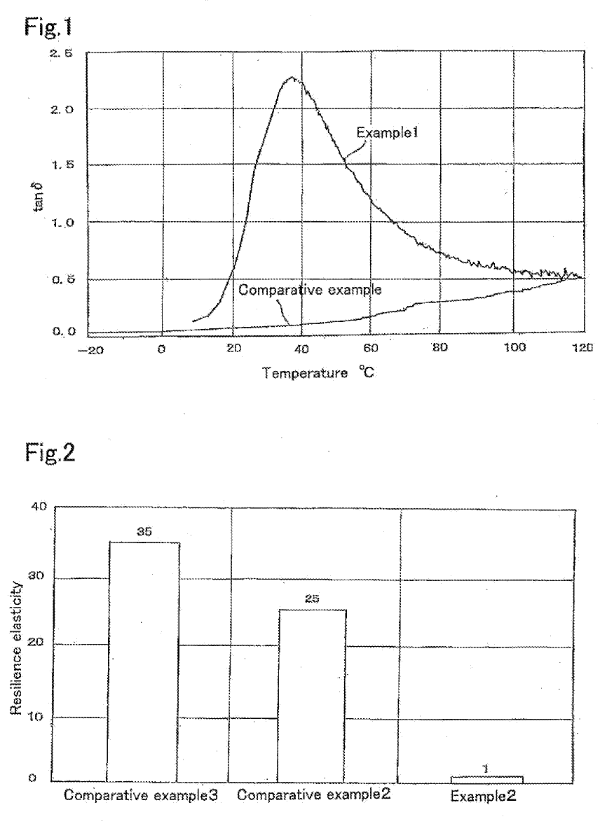

Loss tangent (tan δ) was measured for each of the vibration inhibiting varnish of Example 1 and Comparative example 1 above. The results are depicted in FIG. 1. From FIG. 1, it was confirmed that, while the loss tangent (tan δ) for the varnish of Comparative example 1 had the maximum peak value of about 0.5 in the temperature range of −20° C. to 120° C., the loss tangent (tan δ) for the varnish of Example 1 was about 2.3, showing an excellent vibration inhibiting property.

### Example 2

To 90% by weight of NBR, p-(p-toluenesulfonylamido)diphenylamine was added in an amount of 10% by weight to be kneaded and molded into a sheet to obtain a vibration proofing sheet.

### Comparative Example 2

A vibration proofing sheet was obtained in the same manner as Example 2, except that p-(p-toluenesulfonylamido)diphenylamine was not added.

### Comparative Example 3

By using CR only, a vibration proofing sheet was obtained in the same manner as Example 2.

Resilience elasticity was measured for each of the sheets of Example 2 and Comparative examples 2 and 3 above. The results are depicted in FIG. 2. FIG. 2 shows that the measured values were 35 and 25 for the sheet of Comparative example 3 and Comparative example 2, respectively, but 1 for the vibration proofing inhibiting sheet of Example 2, thereby confirming that the performance was dramatically improved in Example 2.

### Example 3

To 100 parts by weight of NBR, p-(p-toluenesulfonylamido)diphenylamine was added in an amount of 10 parts by weight to be kneaded and molded into a sheet to obtain a vibration inhibiting sheet.

### Example 4

A vibration inhibiting sheet was obtained in the same manner as Example 3, except that 4,4′-bis(α,α-dimethylbenzyl)diphenylamine was added to NBR, instead of p-(p-toluenesulfonylamido)diphenylamine.

### Comparative Example 4

By using NBR only, a vibration inhibiting sheet was obtained in the same manner as Example 3.

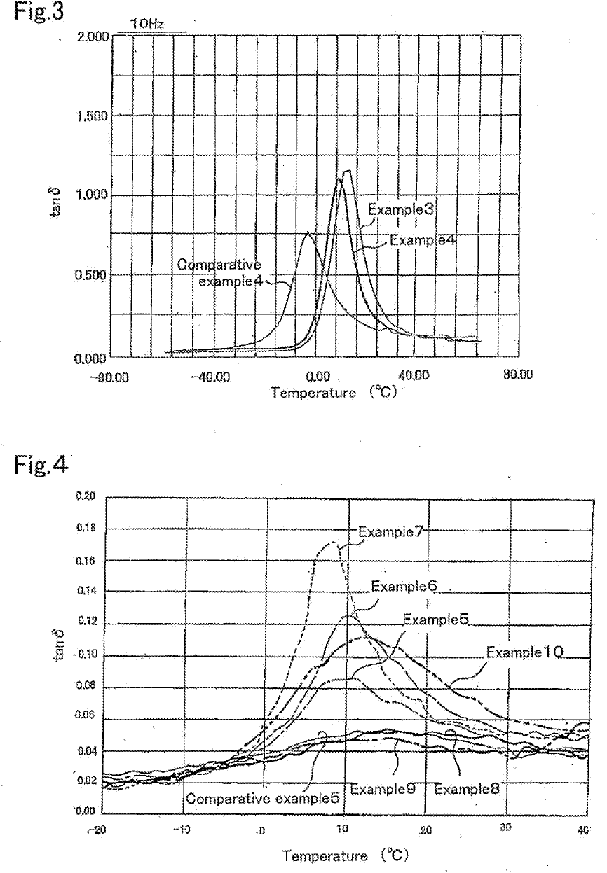

For each of the vibration inhibiting varnish of Examples 3 and 4 and Comparative example 4 above, vibration inhibiting performance (tan δ) was measured in the temperature range of −80 to 80° C. The results are depicted in FIG. 3.

In FIG. 3, it is shown that tan δ for the sheet of Comparative example 4 had the peak value of 0.779 at −2.82° C. while tan δ for the sheet of Example 3 had the peak value of 1.182 at 13.35° C. and tan δ for the sheet of Example 4 had the peak value of 1.133 at 8.84° C. Thus, it was confirmed that the sheets of Examples 3 and 4 had an excellent vibration inhibiting property.

Next, a damping property was evaluated for a case in which the present compound was added to a vibration inhibiting member comprising PP as a base material.

### Example 5

To 90% by weight of PP, 4,4′-bis(α,α-dimethylbenzyl)diphenylamine was added in an amount of 10% by weight to be kneaded and molded into a sheet to obtain a vibration inhibiting sheet.

### Example 6

A vibration inhibiting sheet was obtained in the same manner as Example 5, except that 20% by weight of 4,4′-bis (α,α-dimethylbenzyl) diphenylamine was added to 80% by weight of PP.

### Example 7

A vibration inhibiting sheet was obtained in the same manner as Example 5, except that 30% by weight of 4,4′-bis(α,α-dimethylbenzyl)diphenylamine was added to 70% by weight of PP.

### Example 8

A vibration inhibiting sheet was obtained in the same manner as Example 5, except that 10% by weight of 2,2′-methylenebis(4-ethyl-6-tert-butylphenol) was added to 90% by weight of PP, instead of 4,4′-bis(α,α-dimethylbenzyl)diphenylamine.

### Example 9

A vibration inhibiting sheet was obtained in the same manner as Example 5, except that 10% by weight of p-(p-toluenesulfonylamide)diphenylamine was added to 90% by weight of PP, instead of 4,4′-bis(α,α-dimethylbenzyl)diphenylamine.

### Example 10

A vibration inhibiting sheet was obtained in the same manner as Example 5, except that 10% by weight of 4,4′-thiobis(3-methyl-6-tert-butylphenol) was added to 90% by weight of PP, instead of 4,4′-bis(α,α-dimethylbenzyl)diphenylamine.

### Comparative Example 5

By using PP only, a vibration inhibiting sheet was obtained in the same manner as Example 5.

For each of vibration inhibiting sheets of Examples 5 to 10 and Comparative example 5 above, vibration inhibiting performance (tan δ) was measured in the temperature range of −20° C. to 40° C. The results are depicted in FIG. 4.

According to FIG. 4, it was confirmed that, for the vibration inhibiting sheets of Examples 5 to 7 in which 4,4′-bis(α,α-dimethylbenzyl)diphenylamine was added to PP, each peak was found at near the room temperature region of 0° C. to 25° C. as the addition amount of 4,4′-bis(α,α-dimethylbenzyl)diphenylamine was increased from 10% by weight to 30% by weight, and also with slight shift to low temperature region, tan δ was dramatically increased from about 0.09 to about 0.125, and further to about 0.175.

In addition, according to the curves obtained for each of the vibration inhibiting sheets of Example 5 and Examples 8 to 10 in which a different kind of an additive was added in the same amount, tan δ for Example 8 in which 2,2′-methylenebis(4-ethyl-6-tert-butylphenol) was added and for Example 9 in which p-(p-toluenesulfonylamido)diphenylamine was added were about 0.06, which is similar to tan δ for Comparative example 5 in which no additive was added. However, for Example 5 in which 4,4′-bis(α,α-dimethylbenzyl)diphenylamine was added, the peak of tan δ was broadened to the temperature region of about 0° C. to 20° C. and its peak value was dramatically increased to about 0.09. In addition, for Example 10 in which 4,4′-thiobis(3-methyl-6-tert-butylphenol) was added, the peak of tan δ was further broadened to the temperature region of about 5° C. to 30° C. and its peak value was as high as about 0.11. This has revealed that Example 9 is excellent as an additive for the vibration inhibiting material comprising PP as a base material.

Next, a damping property was evaluated for a case in which the present compound was added to a vibration inhibiting element comprising PET as a base material.

### Example 11

To 90% by weight of PET, 4,4′-bis(α,α-dimethylbenzyl)diphenylamine was added in an amount of 10% by weight to be kneaded and molded into a sheet to obtain a vibration inhibiting sheet.

### Example 12

A vibration inhibiting sheet was obtained in the same manner as Example 11, except that 10% by weight of p-(p-toluenesulfonylamido)diphenylamine was added to 90% by weight of PET, instead of 4,4′-bis(α,α-dimethylbenzyl)diphenylamine.

### Example 13

A vibration inhibiting sheet was obtained in the same manner as Example 11, except that 10% by weight of octylated diphenylamine was added to 90% by weight of PET, instead of 4,4′-bis(α,α-dimethylbenzyl)diphenylamine.

### Example 14

A vibration inhibiting sheet was obtained in the same manner as Example 11, except that 10% by weight of 2,2′-methylenebis(4-ethyl-6-tert-butylphenol) was added to 90% by weight of PET, instead of 4,4′-bis(α,α-dimethylbenzyl)diphenylamine.

### Example 15

A vibration inhibiting sheet was obtained in the same manner as Example 11, except that 10% by weight of 2,4′-thiobis(3-methyl-6-tert-butylphenol) was added to 90% by weight of PET, instead of 4,4′-bis(α,α-dimethylbenzyl)diphenylamine.

### Comparative Example 6

By using PET only, a vibration inhibiting sheet was obtained in the same manner as Example 11.

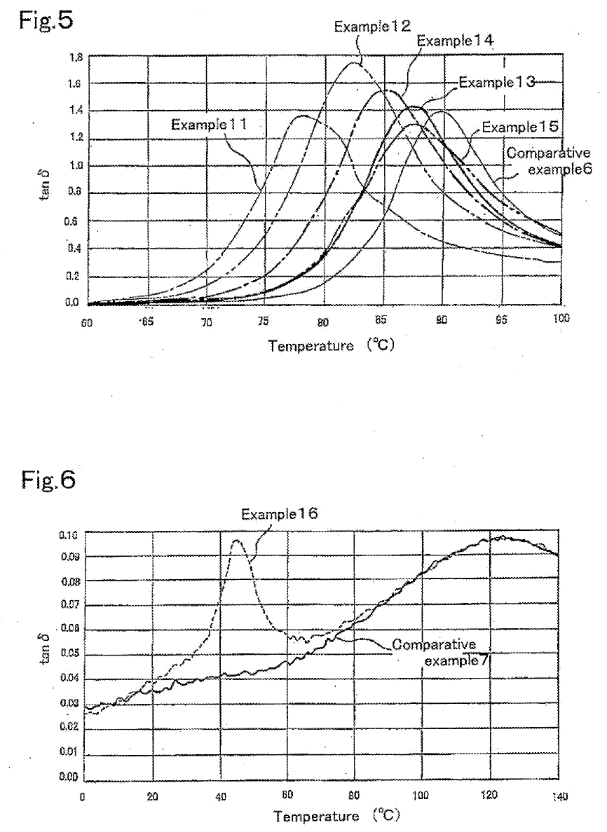

For each of the vibration inhibiting sheets of Examples 11 to 15 and Comparative example 6 above, vibration inhibiting performance (tan δ) was measured in the temperature range of 60° C. to 100° C. The results are depicted in FIG. 5.

According to FIG. 5, the peak of tan δ for the vibration inhibiting sheet of Comparative example 6 is at about 90° C. while the peak values of tan δ for each of the vibration inhibiting sheets of Examples 11 to 15 in which the present compound was added, all shifted to a low temperature region and the peak of tan δ for the vibration inhibiting sheets of Example 13 and Example 15 in which octylated diphenylamine and 4,4′-thiobis(3-methyl-6-tert-butylphenol) were added, respectively, are at about 87° C. In addition, for Example 11 in which 4,4′-bis(α,α-dimethylbenzyl) diphenylamine was added, the peak of tan δ is at about 78° C., showing dramatic shift toward a low temperature region.

It is further confirmed that the peak value of tan δ for Example 14 comprising 2,2′-methylenebis(4-ethyl-6-tert-butylphenol) was about 1.6 at about 85° C., while the peak value of tan δ for Comparative example 6 was about 1.4, showing increase of 0.2. Still further, it was confirmed that the peak of tan δ for Example 12 in which p-(p-toluenesulfonylamido)diphenylamine was added was at about 82° C., and its value was about 1.8, indicating dramatic improvement in a vibration inhibiting property compared to Comparative example 6 having no additives.

Next, a damping property was evaluated for a case in which the present compound was added to a vibration inhibiting member comprising PVDF as a base material.

### Example 16

To 90% by weight of PVDF, p-(p-toluenesulfonylamido)diphenylamine was added in an amount of 10% by weight to be kneaded and molded into a sheet to obtain a vibration inhibiting sheet.

### Comparative Example 7

By using PVDF only, a vibration inhibiting sheet was obtained in the same manner as Example 16.

For each of the vibration inhibiting sheets of Example 16 and Comparative example 7 above, vibration inhibiting performance (tan δ) was measured in the temperature range of 0° C. to 140° C. The results are depicted in FIG. 6.

According to FIG. 6, curves of tan δ for Example 16 and Comparative example 7 each have the peak value of about 0.10 at about 120° C. and show a mild decrease toward a low temperature region. A curve for Comparative example 7 shows continuous decrease in tan δ value while the vibration inhibiting sheet of Example 16 exhibits an additional peak value of about 0.10 at about 40° C.

That is, although high vibration inhibiting performance is obtained in a high temperature region above 100° C. from the vibration inhibiting sheet of Comparative example 7 comprising PVDF only, no such vibration inhibiting performance is expected to be obtained in the temperature range of 30° C. to 50° C. On the contrary, the vibration inhibiting sheet of Example 16 exhibits excellent vibration inhibiting performance both in the high temperature region and the room temperature region. Therefore, it can be applied for much wider range of use.

Next, a damping property was evaluated for a case in which the present compound was added to a vibration inhibiting member comprising EVA as a base material.

### Example 17

To 90% by weight of EVA, 4,4′-bis(α,α-dimethylbenzyl)diphenylamine was added in an amount of 10% by weight to be kneaded and molded into a sheet to obtain a vibration inhibiting sheet.

### Example 18

A vibration inhibiting sheet was obtained in the same manner as Example 17, except that 10% by weight of p-(p-toluenesulfonylamido)diphenylamine was added to 90% by weight of EVA, instead of 4,4′-bis(α,α-dimethylbenzyl)diphenylamine.

### Example 19

A vibration inhibiting sheet was obtained in the same manner as Example 17, except that 10% by weight of octylated diphenylamine was added to 90% by weight of EVA, instead of 4,4′-bis(α,α-dimethylbenzyl)diphenylamine.

### Example 20

A vibration inhibiting sheet was obtained in the same manner as Example 17, except that 10% by weight of 2,2′-methylenebis(4-ethyl-6-tert-butylphenol) was added to 90% by weight of EVA, instead of 4,4′-bis(α,α-dimethylbenzyl)diphenylamine.

### Example 21

A vibration inhibiting sheet was obtained in the same manner as Example 17, except that 10% by weight of 4,4′-thiobis(3-methyl-6-tert-butylphenol) was added to 90% by weight of EVA, instead of 4,4′-bis(α,α-dimethylbenzyl)diphenylamine.

### Example 22

A vibration inhibiting sheet was obtained in the same manner as Example 17, except that the amount of octylated diphenylamine added in Example 19 was changed to 20% by weight.

### Comparative Example 8

By using EVA only, a vibration inhibiting sheet was obtained in the same manner as Example 17.

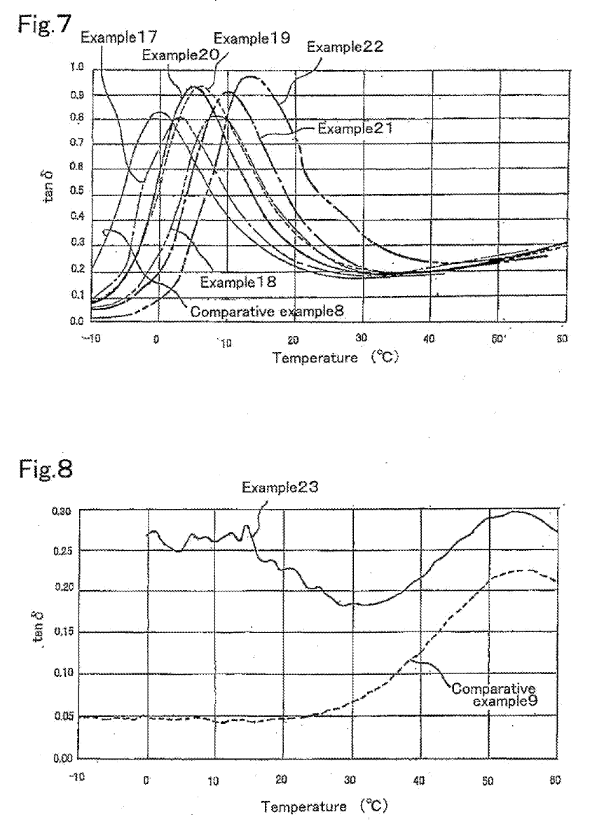

For each of the vibration inhibiting sheets of Examples 17 to 22 and Comparative example 8 above, vibration inhibiting performance (tan δ) was measured in the temperature range of −10° C. to 60° C. The results are depicted in FIG. 7.

According to FIG. 7, it was confirmed that the peak of tan δ for the vibration inhibiting sheet of Comparative example 8 was at about 0° C., while the peak value of tan δ for the vibration inhibiting sheets of Examples 17 to 22 in which the present compound was added, all shifted to a higher temperature region.

In particular, while the peak value of tan δ for Comparative example 8 was about 0.83 at about 0° C., the peak of tan δ for Example 20, 19, 21, 22 shifted to about 3° C., about 5° C., about 10° C. and about 14° C., respectively, and their peak value increased as much as about 1.0 from about 0.9.

Next, a damping property was evaluated for a case in which the present compound was added to a vibration inhibiting member comprising ethylene methacrylate copolymer as a base material.

### Example 23

To 90% by weight of ethylene methacrylate copolymer, octylated diphenylamine was added in an amount of 10% by weight to be kneaded and molded into a sheet to obtain a vibration inhibiting sheet.

### Comparative Example 9

By using ethylene methacrylate copolymer only, a vibration inhibiting sheet was obtained in the same manner as Example 23.

For each of the vibration inhibiting sheets of Example 23 and Comparative example 9 above, vibration inhibiting performance (tan δ) was measured in the temperature range of −10 to 60° C. The results are depicted in FIG. 8.

According to FIG. 8, tan δ for the vibration inhibiting sheet of Comparative example 9 has its peak value of 0.23 at about 55° C., which is then decreased to near 30° C. and then stayed at 0.05 without further decrease.

Meanwhile, tan δ for the vibration inhibiting sheet of Example 23 has its peak at about 55° C., similar to Comparative example 9. However, in a temperature region lower than 20° C., tan δ increases again. Further, its value is in the range of about 0.20 to 0.30 in the temperature region of 0° C. to 60° C., and thus it was confirmed that the value of tan δ was increased overall.

The present invention is not limited to the examples described above, and it can be freely modified within the scope of the claims.

### INDUSTRIAL APPLICABILITY

The organic damping material of the present invention can be applied for a wide range of use. Examples of specific use thereof include a vibration inhibiting material such as a vibration inhibiting sheet, a vibration inhibiting film, a vibration inhibiting paper, vibration inhibiting paint, vibration inhibiting powder paint, vibration inhibiting varnish, vibration inhibiting adhesives, a constrained vibration inhibiting member, and a vibration inhibiting steel plate; a sound absorbing material such as a sound absorbing sheet, a sound absorbing film, a sound absorbing foam, a sound absorbing fiber, and sound absorbing non-woven fabrics; an impact absorbing material used for an grip end for a tennis or badminton racket etc., a shoe sole, a grip for a bicycle or a motorcycle etc., an impact absorbing tape, and an impact absorbing gel or rubber; an electromagnetic wave absorbing material used for a shield for absorbing an electromagnetic wave etc.; a vibration proofing material used for a vibration proofing rubber or a vibration proofing gel etc.; and a heat storing paint material.

Further, since the organic damping material of the invention by itself has properties including an excellent vibration inhibiting property, sound absorbing property, vibration proofing property, impact absorbing property or electromagnetic wave absorbing property without being combined with other material(s), it can be used for an application in which multiple functions are simultaneously required. For example, in the case of a laminated glass which is typically used for a vehicle or a house window, etc., multiple functions including a vibration inhibiting property, a sound absorbing property or an electromagnetic wave absorbing property are required simultaneously. In this regard, since the organic damping material of the invention by itself has an excellent vibration inhibiting property, sound absorbing property, and electromagnetic wave absorbing property, while still maintaining transparency, it is the most appropriate for an intermediate layer of the laminated glass.

Still further, examples of other use of the organic damping material of the invention include a sound-proof panel that is installed along the sides of a road such as freeway. The sound-proof panel which is installed along the sides of a road such as freeway is provided mainly for blocking noises from the road. Recently, an ETC system is adopted in freeways by which toll fees are paid automatically based on wireless communication between an antenna installed at a toll gate and a device installed in a vehicle so that the vehicle can freely pass the toll gate without making a stop. However, the electric wave transmitted from the antenna of the ETC system spreads around the road and neighborhood, and as a result, complaints are reported that the electric wave causes a malfunction of a neighboring household electric equipment or incorrect toll fees are applied to a vehicle because an electric wave from the ETC system is transmitted to the device of the vehicles that are driving on the road led to freeways, for example. In this regard, if a sound-proof panel made of the organic damping material of the invention is installed along the sides of a road, the inconvenience can be avoided with absorption of an electromagnetic wave, in addition to the intrinsic effect of a sound-proof panel such as sound absorption, vibration inhibition, and sound blocking.

1. An organic damping material comprising:
a polymer matrix phase;
a phase dispersed therein comprising one or two or more compounds selected from p-(p-toluenesulfonylamido)diphenylamine, 4,4′-bis(α,α-dimethylbenzyl)diphenylamine, octylated diphenylamine, 2,2′-methylenebis(4-ethyl-6-tert-butylphenol), and 4,4′-thiobis(3-methyl-6-tert-butylphenol).

2. The organic damping material according to claim 1, wherein the matrix phase is composed of a thermoplastic resin.

3. The organic damping material according to claim 2, wherein the thermoplastic resin is at least one or two or more selected from general-purpose plastics and engineering plastics.

4. The organic damping material according to claim 3, wherein the general-purpose plastics are one or two or more selected from polyethylene (PE), polypropylene (PP), polyvinyl chloride (PVC), polystyrene (PS), an acrylonitrile butadiene styrene copolymer (ABS), an acrylonitrile styrene copolymer (AS), polymethyl methacrylate (PMMA), chlorinated polyethylene (CPE) and an ethylene vinyl acetate copolymer (EVA).

5. The organic damping material according to claim 3, wherein the engineering plastics are one or two or more selected from the group consisting of polyamide (PA), polyacetal (POM), polycarbonate (PC), polyphenylene ether (PPE), polybutylene terephtbalate (PBT), polyinethyl pentene (TPX), syndiotactic polystyrene (SPS), polysulfone (SPF), polyether sulfone (PES), polyphthalamide (PPA), polyphenylene sulfide (PPS), polycyclohexylenedimethylene terephthalate (PCT), polyarylate (PAR), polyether imide (PEI), polyetherether ketone (PEEK), thermoplastic polyimide (PI), a liquid crystalline polymer (LCP), a fluorocarbon resin, polyether nitrile (PEN), polyethylene terephthalate (PET), modified polyphenylene ether (mPPE), polylsulfone (PSF) and polyamide imide (PAI), or copolymer thereof.

6. The organic damping material according to claim 1, wherein the matrix phase is composed of a thermoplastic elastomer.

7. The organic damping material according to claim 6, wherein the thermoplastic elastomer is one or two or more selected from thermoplastic styrene (TPS), thennoplastic polyolefin (TPO), thermoplastic polyurethane (TPU), a thermoplastic polyester elastomer (TPEE), a thermoplastic vulcanized elastomer (TPV), a thermoplastic vinylchloride elastomer (TPVC), a thermoplastic polyamide elastomer (PEBAX), and a thermoplastic butyl rubber elastomer which is partially cross-linked with organic peroxide, or copolymer thereof, or a thermoplastic elastomer consisting of a styrene-vinyl isoprene block copolymer, and a mixture or copolymer of polypropylene and a styrene elastomer.

8. The organic damping material according to claim 1, wherein the matrix phase is composed of a thermosetting resin.

9. The organic damping material according to claim 8, wherein the thermosetting resin is one or two or more selected from a phenol resin, a urea resin, a melamine resin, an unsaturated polyester resin, a diallylphthalate resin, an epoxy resin, a urethane resin and a silicone resin, or copolymer thereof.

10. The organic damping material according to claim 9, wherein the thermosetting resin is in a varnish form being dispersed in a solvent.

11. The organic damping material according to claim 10, wherein the thermosetting resin, which is in the varnish form being dispersed in the solvent, is epoxy.

12. The organic damping material according to claim 1, wherein the matrix phase is composed of rubber.

13. The organic damping material according to claim 12, wherein the rubber is one or two or more selected from polybutadiene (PB), nitrile rubber (NBR), natural rubber (NR), butyl rubber (IIR), styrenebutadiene rubber (SBR), chloroprene rubber (CR), a fluoro rubber and silicone rubber, or copolymer thereof.

14. The organic damping material according to claim 1, wherein the matrix phase is composed of gel.

15. The organic damping material according to claim 14, wherein the gel is one or two or more selected from urethane gel and silicone gel.

16. The organic damping material according to claim 1, wherein the matrix phase is composed of a water-based emulsion resin.

17. The organic damping material according to claim 7, wherein the water-based emulsion resin is one or two or more selected from polyinethyl methacrylate (PMMA),. polystyrene (PS), an ethylene vinyl acetate copolymer (EVA) and polyurethane.

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. The organic damping material according to any of claims 1-17, wherein one or two or more compounds selected from p-(p-toluenesulfonylamido)diphenylamine, 4,4′-bis(α,α-dimethylbenzyl)diphenylamine, octylated diphenylamine, 2,2′-methylenebis(4-ethyl-6-tert-butylphenol), and 4,4′-thiobis(3-methyl-6-tert-butylphenol) is contained in a content ratio of 1 to 200 parts by weight compared to 100 parts by weight of the polymer which constitutes the matrix phase.

35. The organic damping material according to any of claims 4, 13, and 15, wherein the organic damping material is a sheet form material.

36. The organic damping material according to claim 35, wherein a constraining layer is disposed on at least one side of the sheet form material.

37. The organic damping material according to claim 36, wherein the constraining layer is a sheet, a film, a net, a plate or a composite thereof which is made of one or more material selected from metal, polymer, rubber, glass and non-woven fabrics.

38. The organic damping material according to any one of claims 4, 8, 13 and 15, wherein the organic damping material has a foam structure.

39. A vibration inhibiting material, wherein the organic damping material according to claim 35 is used as a constitutional material.

40. A vibration inhibiting material, wherein the organic damping material according to claim 36 is used as a constitutional material.

41. A vibration inhibiting material, wherein the organic damping material according to claim 37 is used as a constitutional material.

42. A sound absorbing material, wherein the organic damping material according to claim 35 is used as a constitutional material.

43. A sound absorbing material, wherein the organic damping material according to 38 is used as a constitutional material.

44. A vibration proofing material, wherein the organic damping material according to 35 is used as a constitutional material.

45. An impact absorbing material, wherein the organic damping material according to claim 35 is used as a constitutional material.

46. An electromagnetic wave absorbing material, wherein the organic damping material according to claim 35 is used as a constitutional material.

47. A paint, wherein the organic damping material according to claim 16 is used as a constitutional material.

48. A powder paint, wherein the organic damping material according to claim 5 is used as a constitutional material.

49. An adhesive, wherein the organic damping material according to claims 10 or 16 is used as a constitutional material.

50. A constrained vibration inhibiting member, wherein the organic damping material according to claim 36 is used as a constitutional material.

51. A laminated glass, wherein the organic damping material according to claim 36 is used as a constitutional material.

52. A sound-proof panel, wherein the organic damping material according to claim 36 is used as a constitutional material.
